(19) United States
(12) Patent Application Publication
(10) Pub. No.: US 2007/0219815 A1
(43) Pub. Date: Sep. 20, 2007

(54) Network based method of rating persons giving ratings

(76) Inventors: Andrew Franklin Robinson, Auckland (NZ); Mallika Talla Robinson, Auckland (NZ)

Correspondence Address: YOUNG & THOMPSON, 745 SOUTH 23RD STREET, 2ND FLOOR, ARLINGTON, VA, 22202, US

(21) Appl. No.: 11/589,189

(22) Filed: Oct. 30, 2006

(30) Foreign Application Priority Data
Oct. 28, 2005 (NZ) 543285

(51) Int. Cl. G06Q 10/00; G07G 1/14; G06Q 30/00

(52) U.S. Cl. 705/1; 705/14

(57) ABSTRACT

The invention consists in a computer network based method for rating persons who rate rateable factors. The method comprising the steps of providing a reward to a person making a rating of a rateable factor. The quantum of the reward is adjusted according to at least one criteria, which may be at least one of, promptness of the submission of the rating, to what extent the persons rating deviates from the average rating by other persons to the same rateable factor, and to what extent that persons rating deviates from the average rating of similar rateable factors in the past.

This invention relates to a computer based method of rating persons who rate rateable factors available over a network.

It is common to offer rewards to users for performing specific actions on a network. For example, marketing firms may offer rewards to users for filling out online surveys such as the internet. There is a need, however to reward users for taking time to give a quantitative opinion about a rateable factor such as a written article or piece of information available on their computer network. However, there are difficulties to be overcome in that in giving the reward one must distinguish between users that give actual and considered opinions and those may “just click a button” to earn the reward. It is desirable of course to reward the former more than the latter.

It is therefore an object of the present invention to provide a computer network based method of rating persons who rate rateable factors available over a network which will go at least some distance towards meeting the foregoing requirement in a simple yet effective manner or which will at least provide the public with a useful choice.

Accordingly the invention consists in a computer network based method for rating persons who rate rateable factors comprising the steps of providing a reward to a person making a rating of a rateable factor, the quantum of the reward being adjusted according to at least one criteria.

Preferably the quantum of the reward is adjusted according to at least one of, promptness of the submission of the rating, to what extent the persons rating deviates from the average rating by other persons to the same rateable factor, and to what extent that persons rating deviates from the average rating of similar rateable factors in the past.

Preferably the rateable factors comprise a piece or pieces of information.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

This invention relates to a computer based method of rating persons who rate rateable factors available over a network.

It is common to offer rewards to users for performing specific actions on a network. For example, marketing firms may offer rewards to users for filling out online surveys such as the internet. There is a need, however to reward users for taking time to give a quantitative opinion about a rateable factor such as a written article or piece of information available on their computer network. However, there are difficulties to be overcome in that in giving the reward one must distinguish between users that give actual and considered opinions and those may “just click a button” to earn the reward. It is desirable of course to reward the former more than the latter.

It is therefore an object of the present invention to provide a computer network based method of rating persons who rate rateable factors available over a network which will go at least some distance towards meeting the foregoing requirement in a simple yet effective manner or which will at least provide the public with a useful choice.

Accordingly the invention consists in a computer network based method for rating persons who rate rateable factors comprising the steps of providing a reward to a person making a rating of a rateable factor, the quantum of the reward being adjusted according to at least one criteria.

Preferably the quantum of the reward is adjusted according to at least one of, promptness of the submission of the rating, to what extent the persons rating deviates from the average rating by other persons to the same rateable factor, and to what extent that persons rating deviates from the average rating of similar rateable factors in the past.

Preferably the rateable factors comprise a piece or pieces of information.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawing which is a diagrammatic representation of a method according to one preferred form of the invention.

Assumptions

1. This example assumes the users (persons supplying a rating) in question are interested in the reward being offered. For example, if sufficient US$ or other reward is offered, we can assume that a substantial proportion of users of the computer based network will be motivated to participate in the rating process.
2. We also assume a minimum of 3 users are rating any given rateable factor such as a written article or piece of information. Usually the rateable factor will be in the form of an answer to a query.
3. We also assume an end point in the rating process—that is, that the rateable factor is closed to rating (no more users are allowed to rate the rateable factor) either after (a) a certain amount of time has elapsed (say, for example, 2 weeks), or (b) after the rateable factor has been rated by a fixed number of raters.
4. We also assume users are made aware they can receive the reward for rating the rateable factor before they rate the rateable factor, and that they are made aware, in some manner, that the amount of reward they receive depends on how they rate set against a set of criterium.
5. We also assume a “blind” rating system—that is, that users have no information on how other users have rated the rateable factor until the rateable factor is closed. However, we believe the invention may also work for “open” rating systems, whereby users are aware of the current average rating of the rateable factor before they rate the rateable factor, and before the rateable factor is closed.
6. The rateable factor could be an article, other piece of information, or other factor such as a particular information provider.
   How the Invention Works

The computer network invites queries. Persons answer those queries. This invention provides a means whereby the quality of the answers is rated.

To achieve this end, the invention adjusts reward offered to persons rating the quality of the answers according to at least one criterium. In the preferred form any one or more of three criteria are used being one or any combination of the following:
1. how promptly the rating of the rateable factor is submitted relative to other users rating the same rateable factor
2. how much the users rating deviates from the average rating given by other users to the same rateable factor
3. how much the user's rating deviates from the average rating of similar rateable factor in the past

In the drawing the rateable factor is shown as POD (piece of information).

Formulae

Step 1) Range and Promptness

When a user rates a rateable factor, they are made aware of a range of reward being offered for their rating. The first step is to determine “promptness” of rating and set the range of the reward.

To calculate the minimum and maximum reward offered, we use the following:

Original reward attached to the rateable factor=Price

Maximum number of raters allowed=MaxRate

Position of Rater (e.g. first to rate, second to rate, etc)=Rank
Price×(1+MaxRate−Rank)/MaxRate=Reward

We now have a range of reward being offered that is to say—a maximum and a minimum available reward. So, for example, if the Price is $5, and the MaxRate=10, the maximum reward offered would be $5 for the first rater, $4.50 for the second rater, etc. The minimum reward is the negative value (a penalty) of the same number, e.g. −5$, −$4.50, etc.

After the user has submitted their rating and the rateable factor is closed, we can now distribute the reward based upon their performance.

Step 2) Deviation

We first look at deviation—how much the rating deviated from other ratings of the same rateable factor.

To calculate deviation we use the following:

Rate given by the User=Rate

Average rating given by other users=AvgRate

Total number of ratings given=N

Note: We're assuming a scale of 1-10. Any scale of rating can be made a 1-10 factor.
AvgRate=(Sum of all ratings−Rate)/N−1

We then calculate a Deviance Factor (DF) as follows
[10−(2×Rate−AvgRate)/10]×Reward=Deviance Factor (DF)

Thus we have calculated a Deviance Factor, or DF

So, for example, if 10 users have rated a rateable factor, and the first user rated it a 5, and the average rating given amongst the other users is a 6, the Deviance Factor equals 3/5×Reward.

Using the reward figure for the first rates in Step 1, the Deviance Factor would be $3. A similar calculation can be performed for each rate of Step 1. This is indicated in the drawing as “Rating Given”.

Step 3) Variation

We now look at variation. Variation rewards users for identifying rateable factor which deserve ratings that are far away from the average ratings received for similar rateable factor in the past, (such as rateable factors from a same category of information).

Let the average rating given for similar rateable factor in the past=CatAvg

Maximum variation possible=MaxVar

We first calculate the MaxVar

If CatAvg>=5, then MaxVar=CatAvg. Otherwise, MaxVar=10−CatAvg
{(Rate−0.5×MaxVar)/(0.5×MaxVar)}×Reward.
{(Rate−0.5×MaxVar)/(0.5 MaxVar)}×Reward=Variation Factor (VF)

So, for example, if the CatAvg is 4, so that the MaxVar is 6, and the user rates the rateable factor a 4, the Variation Factor (using the Reward in Step 1) is −$3.33.

Step 4) Distributing Reward

So now we have calculated a Deviation Factor (DF) and a Variation Factor (VF).

The system administrator can now weight the final reward based on these factors.

| | | | | | |
|---|---|---|---|---|---|
| 0 | 1 | 2 | 3 | 4 | 5 |

| | |
|---|---|
| Variation Factor | Deviation Factor |

Weighing more toward DF makes it more important for users to be able to think like their fellow users.

Weighing more toward VF reduces what is sometimes called “group think”, and rewards users for identifying unusual rateable factor.

How a system administrator weights the two factors depends on the CatAvg and what the system administrator is trying to achieve.

We'll call this 1-5 weighting element RateW.

Now the formula we use to calculate how much reward the user receives is
(((10+RateW)−MaxVar/10)×DF)+((MaxVar−RateW)/10)×VF

So, using the above examples, and if we give equal weight to VF and DF, the user receives a $0.33 penalty—that is, the user is penalised $0.33.

The system has determined the User has rated closely to what other users have rated, but the user has also rated closed to a “trend” which has developed in the past, and is therefore—at least in this case—showing an inability to recognise a rateable factor which most likely deserves a higher rating.

Conclusion

We believe that with this invention a web community can now run rateable factor through what might be called “Spontaneous Third Party Juries” comprised of members who are motivated to rate quickly, “thinkingly” and fairly, and thereby, in what is essentially “real time”, the online user community can determine a fair value of a rateable factor for the purpose of trade.

1. A computer network based method for rating persons who rate rateable factors comprising the steps of providing a reward to a person making a rating of a rateable factor, the quantum of the reward being adjusted according to at least one criteria.

2. A computer based network for rating persons as claimed in claim 1 wherein the quantum of the reward is adjusted according to at least one of, promptness of the submission of the rating, to what extent the persons rating deviates from the average rating by other persons to the same rateable factor, and to what extent that persons rating deviates from the average rating of similar rateable factors in the past.

3. A computer based network for rating persons as claimed in claim 1 wherein the rateable factors comprise a piece or pieces of information.

4. A computer based network for rating persons as claimed in claim 2 wherein the rateable factors comprise a piece or pieces of information.
